(19) United States
(12) Patent Application Publication
(10) Pub. No.: US 2011/0205396 A1
(43) Pub. Date: Aug. 25, 2011

(54) APPARATUS AND METHOD, AND COMPUTER READABLE RECORDING MEDIUM FOR PROCESSING, REPRODUCING, OR STORING IMAGE FILE INCLUDING MAP DATA

(75) Inventor: Sung-ki Jin, Suwon-si (KR)

(73) Assignee: Samsung Electronics Co., Ltd., Suwon-si (KR)

(21) Appl. No.: 13/021,877

(22) Filed: Feb. 7, 2011

(30) Foreign Application Priority Data
Feb. 24, 2010 (KR) 10-2010-0016669

(51) Int. Cl. G06K 9/54; G06K 9/36; H04N 5/225; G09G 5/00

(52) U.S. Cl. 348/231.2; 382/305; 382/235; 345/629; 348/E05.024

(57) ABSTRACT

An image processing method includes obtaining image data, obtaining location information regarding a location where the image data has been captured, obtaining map data presenting a map of a location corresponding to the location information, and generating an image file to include the image data and the map data.

### CROSS-REFERENCE TO RELATED PATENT APPLICATION

This application claims the priority benefit of Korean Patent Application No. 10-2010-0016669, filed on Feb. 24, 2010, in the Korean Intellectual Property Office, the disclosure of which is incorporated herein in its entirety by reference.

### BACKGROUND

1. Field of the Invention

One or more embodiments relate to an apparatus, method, and a computer readable recording medium for processing an image. One or more embodiments also relate to a method of storing an image and a computer readable recording medium for storing an image file.

2. Description of the Related Art

An image file may include image data compressed in a predetermined format, thumbnail data regarding the image data, screen nail data, and additional information. Recently, image files in an exchangeable image file (Exif) format have been widely used in image processing apparatuses, such as digital photographing apparatuses. A user may obtain various information regarding a shooting environment by using additional information included in an image file. Due to an increase in demand for smart electronic devices, the importance of additional information included in image files has increased.

### SUMMARY

One or more embodiments include an apparatus, method, and a computer readable recording medium for processing, reproducing, and storing an image file that includes map data.

One or more embodiments also include an image file structure that facilitates a user to reproduce map data included in an image file according to a method of reproducing image data without having to drive a map engine, when the user wants to view the map data.

According to an embodiment, an image processing method includes obtaining image data; obtaining location information regarding a location where the image data has been captured; obtaining map data presenting a map of a location corresponding to the location information; and generating an image file to include the image data and the map data.

The image processing method may further include loading entire map data; and searching the entire map data for the map data of the location corresponding to the location information. The entire map data may include at least one of data that has been stored and data obtained from an external device.

The image processing method may further include encoding the image data; and transforming the map data into a format of the image data. The generating of the image file may include generating the image file by using the encoded image data and the transformed map data.

The obtaining of the image data may include capturing the image data by using an imaging device. The obtaining of the location information may include obtaining global positioning system (GPS) information when the image data has been captured.

The generating of the image file may include allocating a map data field in an exchangeable image file format (Exif); and storing the map data in the map data field.

The generating of the image file may further include storing information indicating whether the map data is present, in the image file.

The image processing method may further include providing a first user interface via which a user selects a plurality of image files; obtaining a plurality of pieces of location information included in the respective selected image files, and a plurality of pieces of shooting time information about when the respective selected image files have been captured; generating path information by arranging pieces of location information according to the pieces of shooting time information; obtaining path map data regarding locations corresponding to the pieces of location information; inserting marks representing a path of the locations in the path map data; and storing the path map data in at least one of the selected image files.

The image processing method may further include transforming the path map data into the same format as image data included in the respective selected image files. The storing of the path map data in at least one of the selected image files may include storing the transformed path map data.

According to another embodiment, an image processing apparatus includes an image data obtaining unit that obtains image data; a location information obtaining unit that obtains location information regarding a location where the image data has been captured; a map data obtaining unit that obtains map data presenting a map of a location corresponding to the location information; and a file generation unit that generates an image file to include the image data and the map data.

According to another embodiment, a non-transitory computer readable storage medium has stored thereon a computer program executable by a processor for performing an image processing method, the method including: obtaining image data; obtaining location information regarding a location where the image data has been captured; obtaining map data presenting a map of a location corresponding to the location information; and generating an image file to include the image data and the map data.

According to another embodiment, an image reproducing method includes determining whether map data is included in an image file that stores an image; and if the image file includes the map data, displaying the map data.

The image reproducing method may further include: if the image file includes the map data, displaying a map mark indicating that the map data is present, together with the image data of the image file. The displaying of the map data may include displaying the map data according to a user input that instructs the map mark to be selected.

The image reproducing method may further include: if the image file includes the map data, determining whether the map data is path map data that presents a path of locations where images included in a plurality of image files have been captured according to time; and if the map data is the path map data, displaying a list of the plurality of image files related to the path map data.

According to another embodiment, a non-transitory computer readable storage medium includes an image data region that stores image data; and a map data region that stores map data presenting a map of a location where the image data has been captured. The map data may be encoded into a format of the image data.

### BRIEF DESCRIPTION OF THE DRAWINGS

The above and other features and advantages will become more apparent by describing in detail exemplary embodiments with reference to the attached drawings in which:

FIG. 1 is a block diagram of an image processing apparatus, according to an embodiment;

FIG. 2 is a block diagram of a central processing unit/digital signal processor (CPU/DSP) included in the image processing apparatus of FIG. 1, according to an embodiment;

FIG. 3 illustrates a structure of an image file, according to an embodiment;

FIG. 4 is a flowchart illustrating an image processing method, according to an embodiment;

FIG. 5 is a block diagram of a path generation mode processing unit included in the CPU/DSP of FIG. 2, according to an embodiment;

FIG. 6 illustrates an example of a screen of a first user interface (UI);

FIG. 7 illustrates path map data that includes path information, according to an embodiment;

FIG. 8 is a flowchart illustrating a method of performing a path generation mode, according to an embodiment;

FIG. 9 is a flowchart illustrating an image reproducing method, according to an embodiment;

FIG. 10 illustrates a screen image in which map data is displayed according to a predetermined input from a user, according to an embodiment;

FIG. 11 illustrates a screen image in which map data is displayed when a map mark is selected, according to an embodiment;

FIG. 12 is a flowchart illustrating an image reproducing method performed when map data is present in an image file, according to another embodiment; and

FIG. 13 illustrates a screen image in which path map data is displayed, according to an embodiment.

### DETAILED DESCRIPTION

The following description and accompanying drawings are provided for better understanding of the disclosed embodiments. In the following description, well-known functions or constructions are not described in detail if it is determined that they would obscure understanding of the invention as defined by the following claims due to unnecessary detail.

The following description and drawings are not intended to restrict the scope of the invention as defined by the following claims.

The terms used in the following description are merely used to describe particular embodiments and should not be construed as limiting.

Hereinafter, exemplary embodiments will be described with reference to the accompanying drawings.

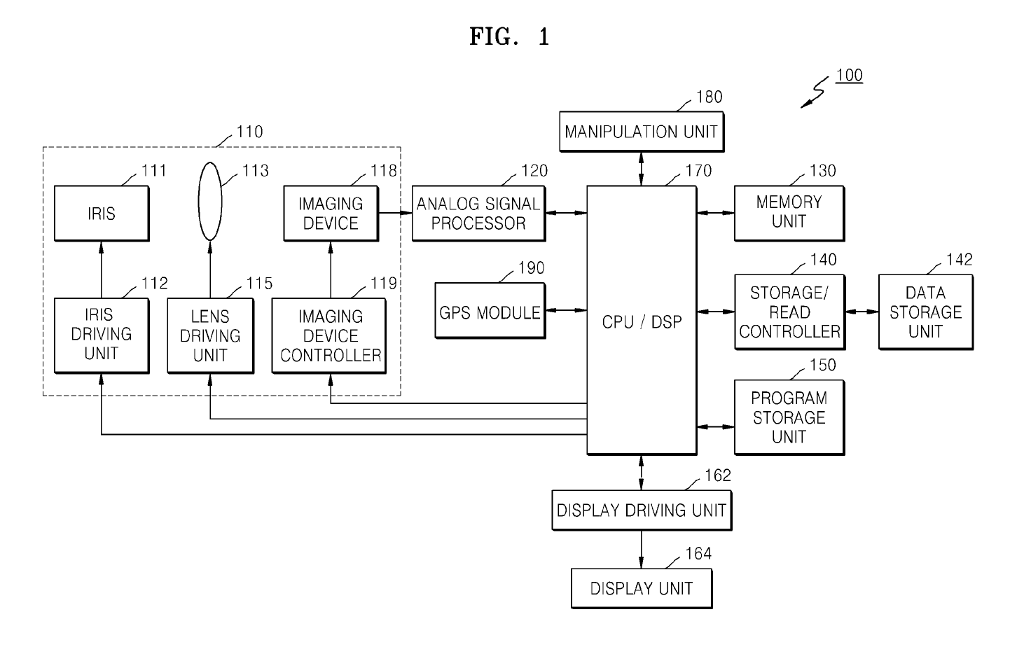

FIG. 1 is a block diagram of an image processing apparatus 100, according to an embodiment. The image processing apparatus 100 may be a digital photographing apparatus having a photographing function, and an image supplied to the image processing apparatus 100 may be captured by a digital photographing apparatus. FIG. 1 briefly illustrates a structure of the image processing apparatus 100 that is embodied as a digital photographing apparatus.

In the current embodiment, the image processing apparatus 100 includes a photographing unit 110, an analog signal processor 120, a memory unit 130, a storage/read controller 140, a data storage unit 142, a program storage unit 150, a display driving unit 162, a display unit 164, a central processing unit/digital signal processor (CPU/DSP) 170, and a manipulation unit 180.

The CPU/DSP 170 controls an overall operation of the image processing apparatus 100. The CPU/DSP 170 supplies a control signal to an iris driving unit 112, a lens driving unit 115, and an imaging device controller 119 in order to operate them.

The photographing unit 110 is a device that generates an electrical signal of an image from incident light. The photographing unit 110 includes an iris 111, the iris driving unit 112, a lens unit 113, a lens driving unit 115, an imaging device 118, and an imaging device controller 119.

The degree of openness of the iris 111 is controlled by the iris driving unit 112. An amount of light incident on the imaging device 118 is controlled by using the iris 111.

The lens unit 113 may include a plurality of lenses, such as a zoom lens and a focus lens. The location of the lens unit 113 is controlled by using the lens driving unit 115. The lens driving unit 115 controls the location of the lens unit 113 according to a control signal received from the CPU/DSP 170.

An optical signal passing through the iris 111 and the lens unit 113 is focused on a light-receiving surface of the imaging device 118 to form an image of a subject. The imaging device 118 may be a charge coupled device (CCD) image sensor or a complementary metal oxide semiconductor image sensor (CIS) that transforms an optical signal into an electrical signal. For example, the sensitivity of the imaging device 118 may be controlled by the imaging device controller 119. The imaging device controller 119 may control the imaging device 118 according to either a control signal that is generated automatically from an image signal input in real time or a control signal that is input directly by a user.

An exposure time of the imaging device 118 is controlled by a shutter (not shown). Examples of the shutter include a mechanical shutter that controls an amount of incident light by moving a screen, and an electronic shutter that controls an exposure time of the imaging device 118 by supplying an electrical signal to the imaging device 118.

The analog signal processor 120 performs noise reduction, gain control, waveform shaping, and analog-to-digital conversion on an analog signal received from the imaging device 118.

A signal processed by the analog signal processor 120 may be supplied to the CPU/DSP 170 directly or via the memory unit 130. The memory unit 130 operates as a main memory unit of the image processing apparatus 100 and temporarily stores information needed during the operation of the CPU/DSP 170. The program storage unit 150 stores programs, e.g., an operating system for driving the image processing apparatus 100 and an application system.

The image processing apparatus 100 may further include a display unit 164 that displays an operating state of the image processing apparatus 100 or information regarding an image captured by the image processing apparatus 100. The display unit 164 may provide a user with visual and/or audio information. In order to provide visual information, the display unit 164 may include, for example, a liquid crystal display panel (LCD) and an organic light-emitting display panel (OLED). The display unit 164 may be a touch screen that senses a touch of a user's finger or an object.

The display driving unit 162 supplies a driving signal to the display unit 164.

The CPU/DSP 170 processes a received image signal and controls the other constitutional elements of the image processing apparatus 100 according to the image signal or an external input signal. The CPU/DSP 170 may perform image signal processing on received image data, e.g., noise reduction, gamma correction, color filter array interpolation, color matrix processing, color correction, and color enhancement, in order to improve image quality. The CPU/DSP 170 may also generate an image file by compressing image data obtained through image signal processing, and reconstruct the image data from the image file. Here, the image data may be compressed by using reversible compression or irreversible compression. For example, a still image may be transformed into a JPEG (Joint Photographic Experts Group) format or a JPEG 2000 format. Also, in order to record a moving picture, a moving picture file may be generated by compressing a plurality of frames according to the MPEG (Moving Picture Experts Group) standards.

Image data output from the CPU/DSP 170 is supplied to the storage/read controller 140 directly or via the memory unit 130. The storage/read controller 140 stores image data in the data storage unit 142 according to a signal received from a user or automatically. Also, the storage/read controller 140 may read data related to an image based on an image file stored in the data storage unit 142 and supply the result of reading to the display driving unit 162 via the memory unit 130 or another path so that the image may be displayed on the display unit 164. The data storage unit 142 may be detachable from or be fixedly installed in the image processing apparatus 100.

The CPU/DSP 170 may also perform sharpness adjustment, color processing, blurring processing, edge enhancement, image interpretation, image recognition, and image effect processing. Image recognition may include face recognition and scene recognition. Furthermore, the CPU/DSP 170 may perform image signal processing on an image to be displayed on the display unit 164. For example, the CPU/DSP 170 may perform brightness control, color correction, contrast control, edge enhancement, image division, character image generation, and image synthesizing. The CPU/DSP 170 may be connected to an external monitor so as to display a result of the image signal processing on the external monitor. The CPU/DSP 170 may execute a program stored in the program storage unit 130. The CPU/DSP 170 may include an additional module to generate a control signal for controlling auto focusing, a zooming step change, a focus change, automatic exposure and to supply the control signal to the iris driving unit 112, the lens driving unit 115, and the imaging device controller 119. The CPU/DSP 170 may also perform overall control of the elements of the image processing apparatus 100, e.g., the shutter and a flash.

A user may input a control signal via the manipulation unit 180. The manipulation unit 180 may include various function buttons, such as a shutter-release button to supply a shutter-release signal for exposing the imaging device 118 to light for a predetermined time in order to capture an image, a power button to supply a control signal for powering on or off, a wide angle-zoom button and a telephoto-zoom button for widening or narrowing a viewing angle, a mode selection button for selecting a character input mode, a photographing mode, or a play mode, a white balance setting button, and an exposure setting button. The type of the manipulation unit 180 is not limited and may be, for example, a button unit, a keyboard, a touch pad, a touch screen, or a remote controller, via which a user may input a control signal.

A global positioning system (GPS) module 190 may calculate the location of the image processing apparatus 100 by receiving a plurality of satellite signals. For example, the location of the image processing apparatus 100 may be calculated by measuring an exact time and distance between the image processing apparatus 100 and each of three or more satellites according to a triangulated method by using three or more satellite signals received from the three or more satellites.

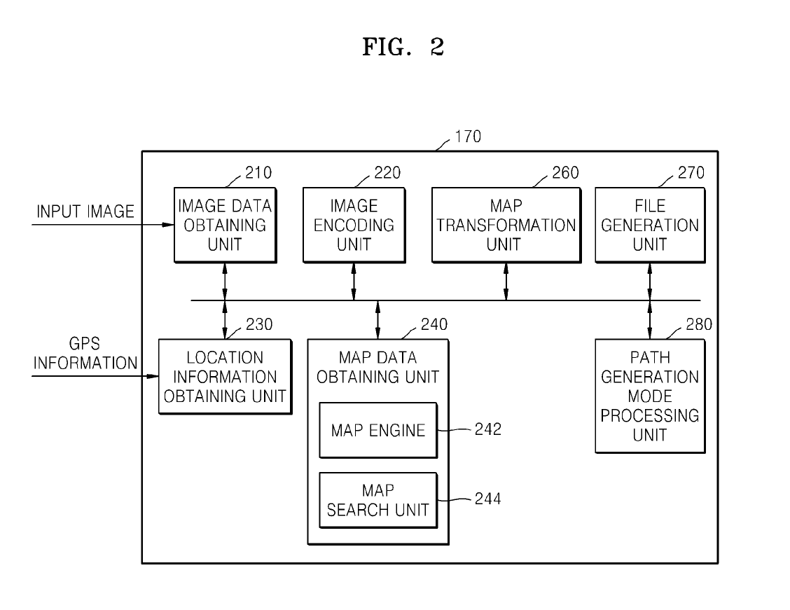

FIG. 2 is a block diagram of the CPU/DSP 170 included in the image processing apparatus 100 of FIG. 1, according to an embodiment. According to an embodiment, the image processing apparatus 100 generates an image file that includes both image data and map data. In the current embodiment, the image processing apparatus 100 encodes the map data into a format of the image data and inserts the map data into the image file. In the current embodiment, the CPU/DSP 170 of the image processing apparatus 100 includes an image data obtaining unit 210, an image encoding unit 220, a location information obtaining unit 230, a map data obtaining unit 240, a map transformation unit 260, a file generation unit 270, and a path generation mode processing unit 280.

The image data obtaining unit 210 obtains image data to be included in an image file. For example, if the image processing apparatus 100 is a digital photographing apparatus, then an image input to the image data obtaining unit 210 may be a captured image that is generated by the photographing unit 110 and processed by the analog signal processor 120. The captured image may be provided, for example, in the form of RAW data. As another example, if the image processing apparatus 100 processes an image file that has already been generated, an image input to the image data obtaining unit 210 may be image data included in the image file, which has been compressed or is raw data that has not been compressed.

The image encoding unit 220 encodes image data obtained by the image data obtaining unit 210. In this case, the image data may be encoded into a predetermined format or a format selected by a user. For example, the image data may be compressed according to the JPEG standards. If the image data is moving picture data, the image data may be compressed according to the MPEG standards. If an image input to the image data obtaining unit 210 is obtained from an already generated image file and has been compressed as described above, then a process of compressing the image data by the image encoding unit 220 may be omitted.

The location information obtaining unit 230 obtains location information regarding a location where image data has been captured by the image data obtaining unit 210. The location information may be obtained by using, for example, the GPS module 190 of the image processing apparatus 100. As another example, if the image processing apparatus 100 processes an image file that has already been generated, then the location information obtaining unit 230 may obtain location information corresponding to image data obtained by the image data obtaining unit 210 from location information included in the image file. The location information may indicate the latitude and longitude of a location where an input image has been captured.

The map data obtaining unit 240 obtains map data by searching for a map of a target location based on location information obtained by the location information obtaining unit 230. The map data obtaining unit 240 may include a map engine 242 and a map search unit 244.

The map engine 242 loads entire map data that has been stored or is provided from outside the image processing apparatus 100. The entire map data may include a base map or a processed map. The base map contains fundamental map elements, e.g., only a main outline of the whole continent and basic geographic features. In general, a size of the base map is very large. The processed map is made by a user in such a manner that, for example, main streets, detailed geographical features, and names may be displayed therein. In general, a size of the processed map is small and a separate processed map may be made for each country. The map engine 242 calls the entire map data and transforms it according to the type of the display unit 164. For example, if the image processing apparatus 100 according to the current embodiment is a digital photographing apparatus, the entire map data may be transformed into a JPEG having a YUV422 format. The entire map data may be stored based on coordinates (latitude and longitude) of each location.

The map search unit 244 searches entire map data loaded to the map engine 242 for map data of a location corresponding to location information obtained by the location information obtaining unit 230. For example, if the entire map data is based on the latitude and longitude of each location and the location information also contains the latitude and longitude of each location, then map data corresponding to a target latitude and longitude may be detected in the entire map data, based on the location information. In this case, a search range of a map covering neighboring regions of the location corresponding to the location information may be predetermined or may be selected by a user. For example, it is possible to search for map data of a location within a radius of 10 km from the location corresponding to the location information, according to an embodiment. According to another embodiment, a user may determine the search range of a map to be, for example, 5 km, 10 km, or 15 km. The map search unit 244 supplies the detected map data to the map transformation unit 260.

The map transformation unit 260 transforms the detected map data. For example, the detected map data may be transformed into a format in which the image data has been encoded. If the image data has been encoded according to the JPEG standards, then the map data is transformed into a JPEG format. If the image data is moving picture data, then the map data may be transformed into a predetermined format. For example, if the image data is moving picture data and has been encoded into an MPEG format, then the map data may be transformed into the JPEG format. If a format that the map engine 242 uses to reproduce the entire map data is the same as a format that the image encoding unit 220 has used to encode the image data, then the map transformation unit 260 may not be installed. The map transformation unit 260 may also transform path map data which will be described later in detail.

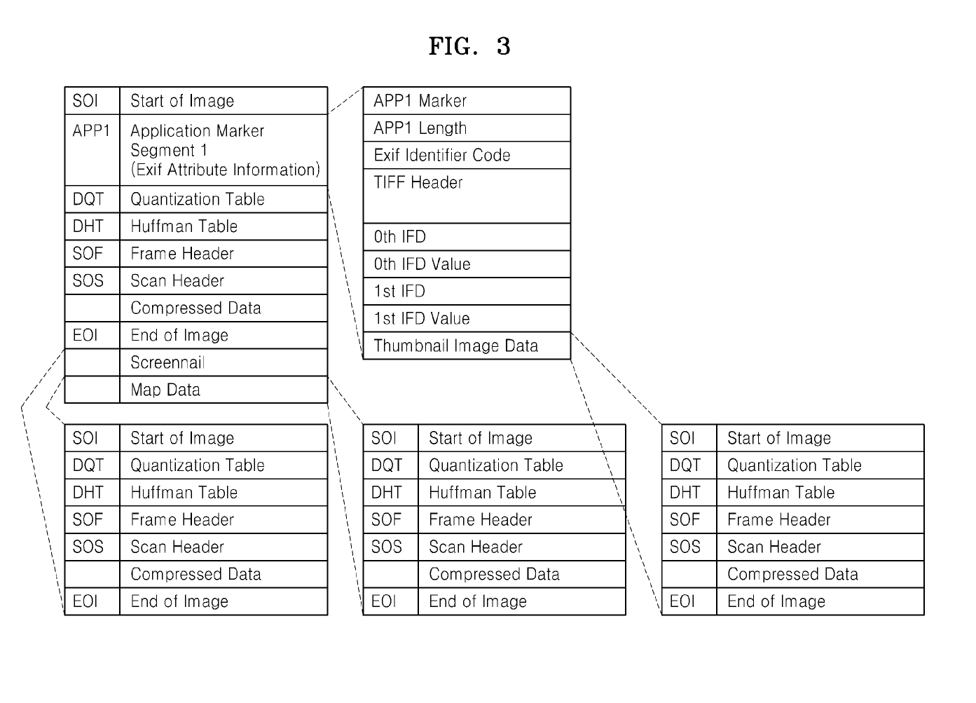

The file generation unit 270 generates an image file by using the encoded image data and the transformed map data. The image file may be generated in a predetermined format, e.g., an exchangeable image file (Exif) format. According to the current embodiment, the file generation unit 270 generates an image file that includes the image data and the map data. An embodiment of the structure of the image file generated by the file generation unit 270 will be described with reference to FIG. 3.

FIG. 3 illustrates a structure of an image file, according to an embodiment. An image file generated according to an embodiment may have a structure according to an Exif format as illustrated in FIG. 3. A file compressed in the Exif format may include a start of image marker SOI, an application marker segment 1 APP1 that contains Exif attribute information, a quantization table field DQT, a Huffman table field DHT, a frame header SOF, a scan header SOS, a compressed data field, an end of image marker EOI, a screennail field, and a map data field.

The application marker segment 1 APP1 may include an APP1 marker, an APP1 length field, an Exif identifier code field, a TIFF header, a 0^{th} field 0^{th} IFD that indicates the attributes of a compressed image, a 0^{th} IFD value field, a 1^{st} field 1^{st} IFD that stores information regarding a thumbnail, a 1^{st} IFD value field, and a thumbnail image data field. The thumbnail image data field may include a start of image marker SOI, a quantization table field DQT, a Huffman table field DHT, a frame header SOF, a scan header SOS, a compressed data field, and end of image markers EOI.

The screennail field may also include a start of image marker SOI, a quantization table field DQT, a Huffman table field DHT, a frame header SOF, a scan header SOS, a compressed data field, and end of image markers EOI.

In the current embodiment, the image file may further include a map data field as illustrated in FIG. 3. The map data field may include a start of image marker SOI, a quantization table field DQT, a Huffman table field DHT, a frame header SOF, a scan header SOS, a compressed data field, and end of image markers EOI.

Referring to FIGS. 1 and 2, in order to generate and store an image file, the file generation unit 270 may allocate storage spaces corresponding to a plurality of regions of the image file, and particularly, a map data field to the memory unit 130 or the data storage unit 142.

Furthermore, the file generation unit 270 may insert information indicating whether map data is present or not, into the image file. For example, the file generation unit 270 may indicate whether map data is present or not, in a maker's note region included in the application marker segment 1 APP1. Also, the file generation unit 270 may insert information indicating whether path map data is present or not, which will be described later, into the image file.

The path generation mode processing unit 280 performs a path generation process when the image processing apparatus 100 according to the current embodiment enters a path generation mode according to a user's selection. The path generation mode will be described in detail later.

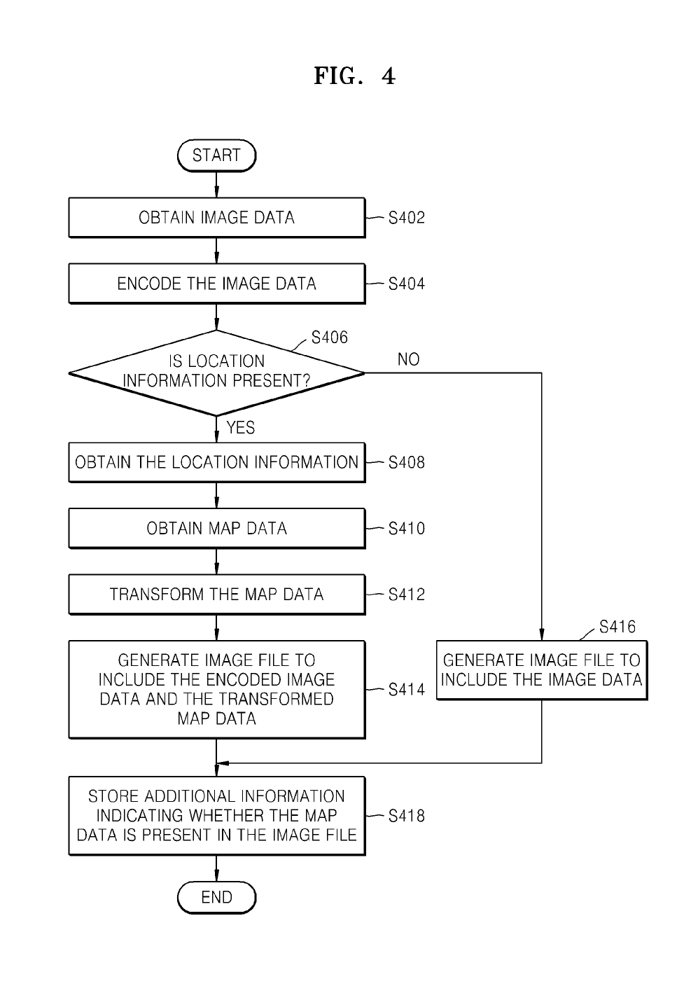

FIG. 4 is a flowchart illustrating an image processing method, according to an embodiment. In the image processing method according to the current embodiment, first, image data that is to be included in an image file is obtained (operation S402). For example, if the image processing method according to the current embodiment is performed by a digital photographing apparatus, then the image data may be obtained by the imaging device 118 of FIG. 1.

Next, the image data is encoded into a predetermined format (operation S404). For example, the image data may be encoded according to the JPEG standards. If the image data is moving picture data, then the image data may be encoded according to the MPEG standards. Although FIG. 4 illustrates that the encoding of the image data (operation S404) is performed before obtaining location information and obtaining map data, the encoding of the image data (operation S404) may be performed at any time before the image file is generated. That is, the encoding of the image data (operation S404) may be performed after or in parallel with obtaining location information and performing processes related to the map data.

Next, it is determined whether location information corresponding to a location where the image data was obtained is present (operation S406). If it is determined in operation S406 that the location information is not present, then an image file that includes the image data is generated (operation S416). If it is determined in operation S406 that the location information is present, then the location information is obtained (operation S408) and map data corresponding to the location information is obtained (operation S410). The map data may be obtained as described above with reference to the map data obtaining unit 240. Next, the map data is transformed (operation S412). In this case, the map data may be transformed into a format into which the image data has been encoded. For example, if the image data has been encoded into the JPEG format, the map data is transformed into the JPEG format. If the image data is moving picture data, the map data may be transformed into a predetermined format.

Next, an image file that includes the encoded image data and the transformed map data is generated (operation S414). Next, additional information indicating whether the map data is present is stored in the image file (operation S418).

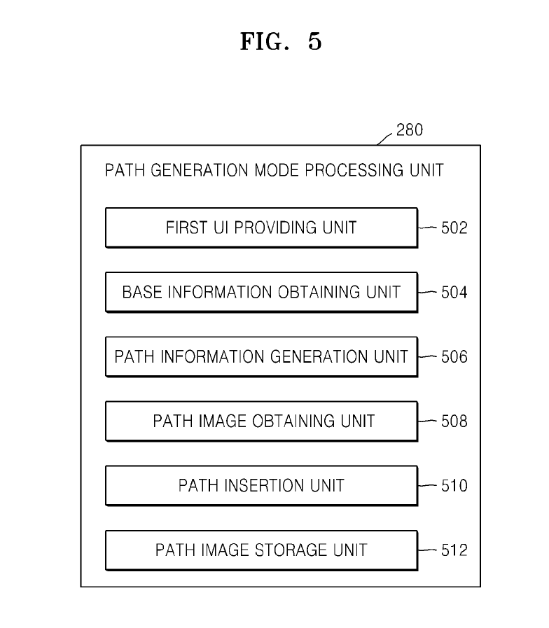

FIG. 5 is a block diagram of the path generation mode processing unit 280 included in the CPU/DSP 170 of FIG. 2, according to an embodiment. According to an embodiment, information regarding a path navigated by a user may be obtained using a plurality of image files, and path map data indicating the path of movement may be generated and inserted into an image file. In the current embodiment, the path generation mode processing unit 280 may include a first user interface (UI) providing unit 502, a base information obtaining unit 504, a path information generation unit 506, a path image obtaining unit 508, a path insertion unit 510, and a path image storage unit 512.

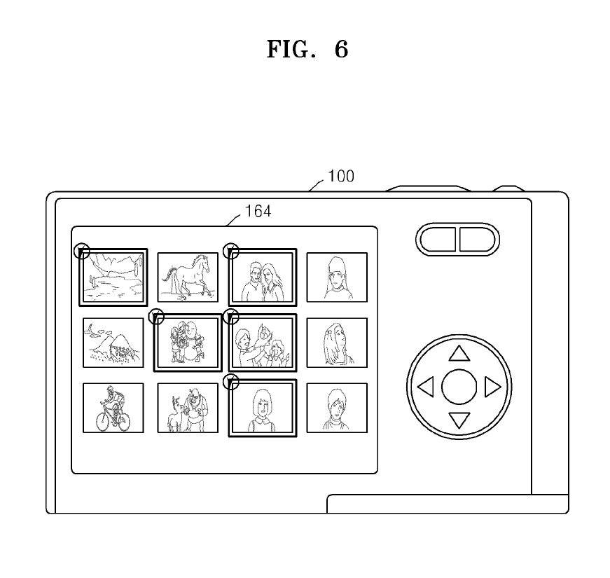

The first UI providing unit 502 provides a first UI via which the user may select at least one image file, the path information of which is to be generated. FIG. 6 illustrates an example of a screen of the first UI. Referring to FIG. 6, the first UI may represent a list of a plurality of image files that the user may select, and the user may select desired image files, the path information of which are to be generated.

The base information obtaining unit 504 obtains a plurality of pieces of location information of the respective selected image files and shooting time information about when the selected image files were captured. For example, the pieces of location information may be obtained using the GPS module 190.

The path information generation unit 506 generates path information regarding the movement of the user by arranging the pieces of location information of the respective selected image files according to the shooting time information.

The path image obtaining unit 508 obtains path map data representing locations corresponding to the pieces of location information of the selected image files. To this end, the path image obtaining unit 508 may define an area to include locations corresponding to all the pieces of location information of the selected image files and detect map data of the defined area by using the map data obtaining unit 240 in order to obtain the path map data.

The path insertion unit 510 inserts the path data into path image data.

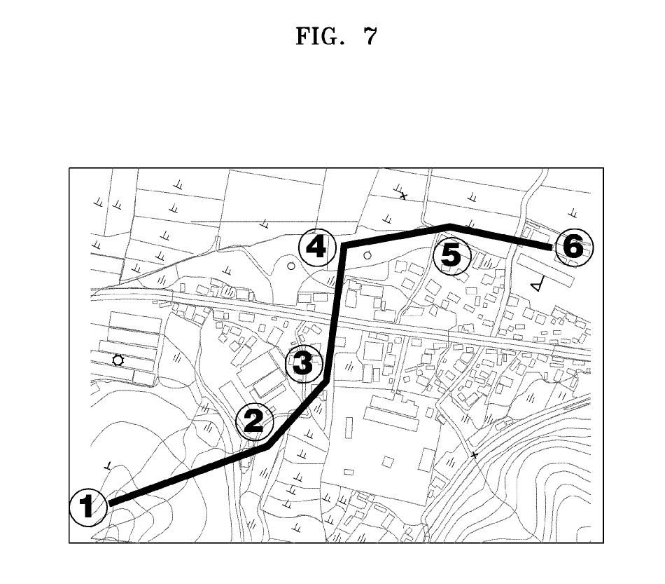

FIG. 7 illustrates path map data that includes path information, according to an embodiment. Referring to FIG. 7, in the path map data according to the current embodiment, locations corresponding to a plurality of pieces of location information of a plurality of image files may be indicated and marks may be allocated to the locations according to an order of movement of a user.

Referring back to FIG. 5, the path image storage unit 512 stores the path map data including the path information in such a manner that the path map data may be related to at least one of the selected image files.

For example, the path image storage unit 512 may select at least one of the plurality of image files and insert the path map data into the selected at least one image file. The path map data may be stored in a map data field of at least one of the selected image files. The path map data may be inserted into an image file that was captured first from among the selected image files. Otherwise, the path map data may be inserted into all image files that the user selects from among the plurality of image files. The path image storage unit 512 may also store the names of the image files related to the path data in the image files that the user selects from among the plurality of image files. If the path map data is stored in a first image file but is not stored in a second image file from among the plurality of image files, then the second image file may include information indicating that the path map data is present in the first image file and information regarding the first image file.

As another example, the path image storage unit 512 may insert information regarding the path map data in at least one of the selected image files and store the path map data in a separate file. In this case, at least one of the selected image files may store the location and name of the separate file in which the path map data has been stored, and the names of the selected image files on which the path of movement of the user is based.

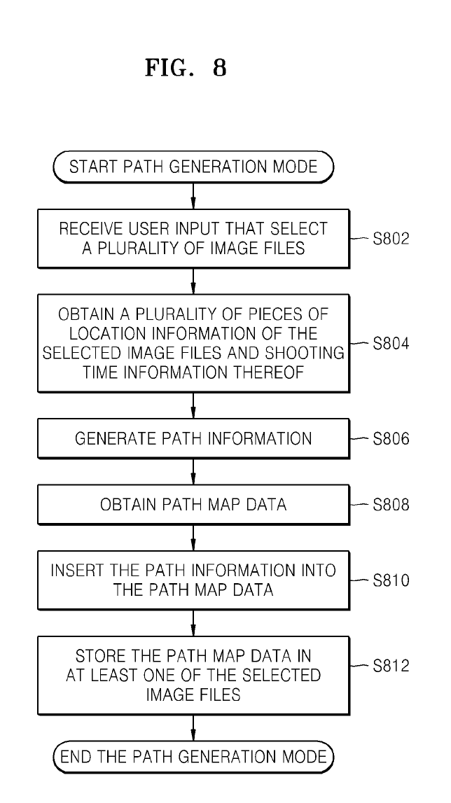

FIG. 8 is a flowchart illustrating a method of performing a path generation mode, according to an embodiment. First, a user input that selects a plurality of image files for generation of path map data is received via a first UI (operation S802). The first UI may be as illustrated in FIG. 6.

Next, a plurality of pieces of location information of the selected image files and shooting time information about when the selected image files were captured are obtained (operation S804). Then, path information is generated by arranging the pieces of location information according to the shooting time information (operation S806). Next, an area is defined to include locations corresponding to the pieces of location information of the respective selected image files, and path map data of the area is obtained (operation S808). Then, the path information is inserted into the path map data (operation S810). For example, the path information may be inserted as illustrated in FIG. 7. Next, the path map data is stored to be related to at least one of the selected image files (operation S812). That is, the path map data may be stored to be related to a map data field of at least one of the selected image files, or the path map data may be stored in a separate file and information regarding the path map data may be stored in at least one of the selected image files.

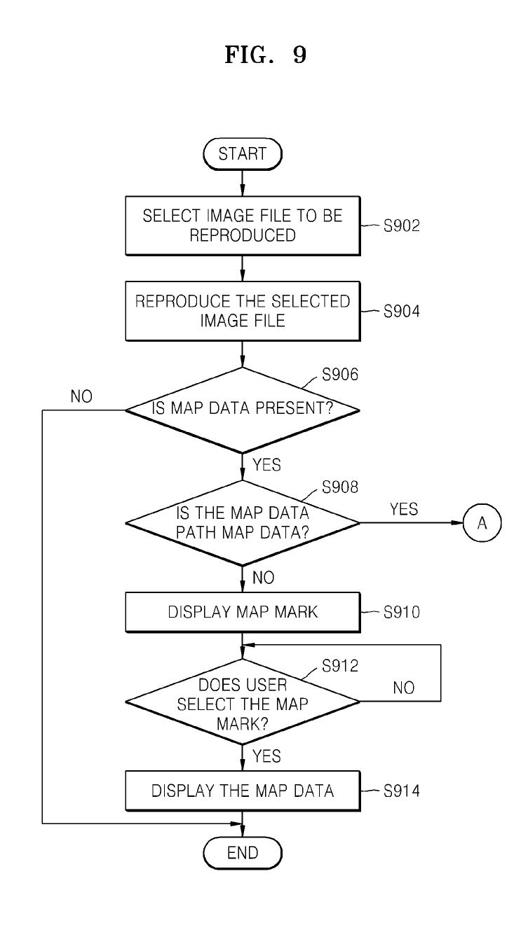

FIG. 9 is a flowchart illustrating an image reproducing method, according to an embodiment. In the current embodiment, if map data is included in an image file, the map data may be viewed during reproduction of the image file.

In the image reproducing method according to the current embodiment, when a user selects an image file that is to be reproduced (operation S902), the selected image file is reproduced (operation S904) and it is determined whether map data is included in the image file (operation S906). Whether map data is included in the image file may be determined based on information that has been included in the image file in order to indicate this fact. If it is determined in operation S906 that map data is included in the image file, the map data may be displayed in various ways.

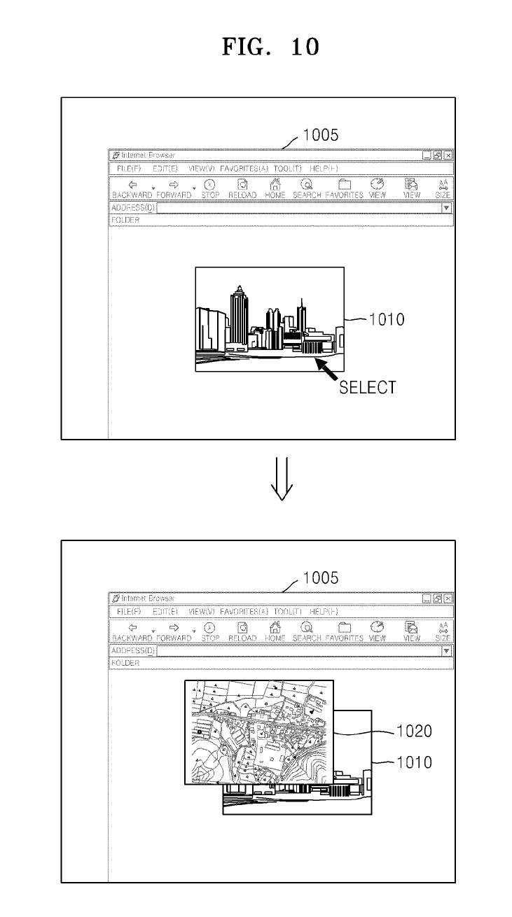

For example, the map data may be displayed when a predetermined input from a user is received. FIG. 10 illustrates a screen image in which map data is displayed according to a predetermined input from a user, according to an embodiment. Particularly, FIG. 10 illustrates a case where an image file is displayed using a web browser 1005. According to an embodiment, if the image file is displayed in a first region 1010 and a user selects the first region 1010 in the web browser 1005, then map data may be displayed in a second region 1020. Accordingly, the user may more conveniently obtain information regarding a location where image capturing was performed.

As another example, if it is determined in operation S906 that map data is included in the image file, a map mark indicating the map data is present is displayed (operation S910), and the map data may be displayed (operation S914) when the user selects the map mark (operation S912).

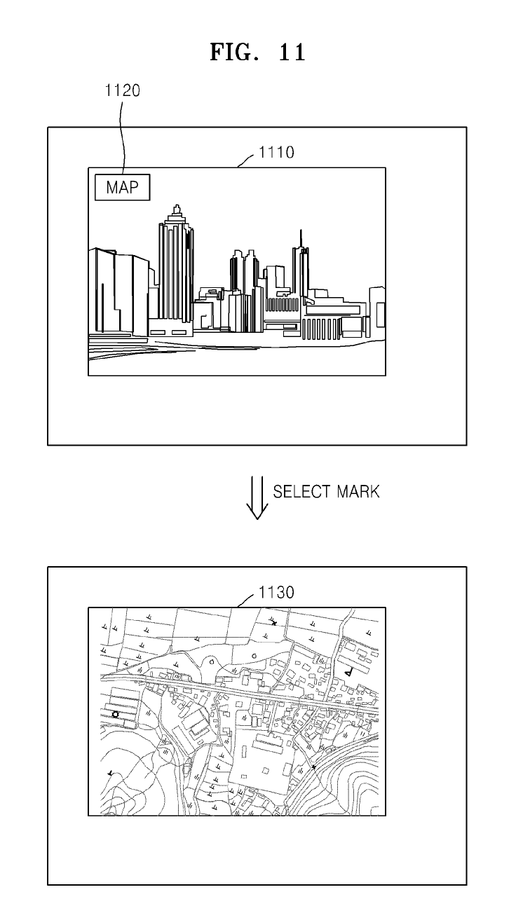

FIG. 11 illustrates a screen image in which map data 1130 is displayed when a map mark is selected, according to an embodiment. Referring to FIG. 11, if map data is present in displayed image data 1110, a map mark 1120 indicating that the map data is present may be displayed together with the image data 1110. When a user selects the map mark 1120, map data 1130 included in an image file may be displayed.

Referring back to FIG. 9, in the current embodiment, if it is determined in operation S906 that map data is included in the image file, it is determined whether the map data is path map data (operation S908). Whether the map data is path map data may be determined by using the attributes of the map data that are included in the image file or information indicating whether the path map data is present or not.

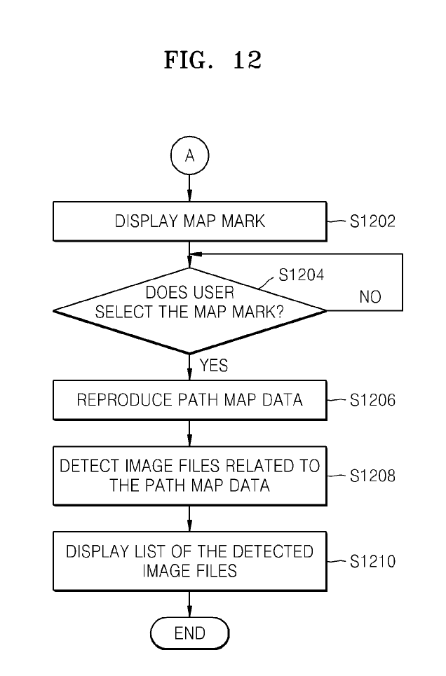

FIG. 12 is a flowchart illustrating an image reproducing method performed when map data is present in an image file, according to another embodiment.

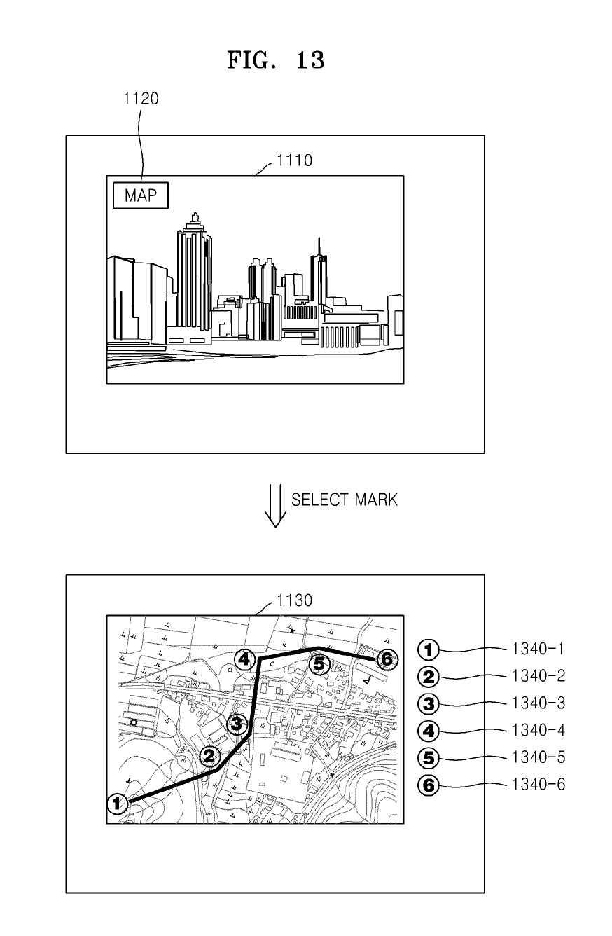

If the map data included in the image file is path map data, the path map data may also be displayed according to a predetermined input from a user or a selected map mark as described above. FIG. 12 is related to a case where path map data is displayed when a map mark is selected. FIG. 13 illustrates a screen image in which path map data 1130 is displayed, according to an embodiment.

In the image reproducing method of FIG. 12, referring back to FIG. 9, if it is determined in operation S908 that the map data is path map data, then a map mark 1120 is displayed together with image data 1110 as illustrated in FIG. 13 (operation S1202). Next, when a user selects the map mark 1120 (operation S1204), the path map data 1130 is reproduced (operation S1206). Next, image files related to the path map data 1130 are detected (operation S1208), and then, a list of the detected image files may be displayed (operation S1210). For example, referring to FIG. 13, a plurality of marks 1340-1, 1340-2, 1340-3, 1340-4, 1340-5, and 1340-6 representing a plurality of image files on which the path map data 1130 is based, may be displayed together with the path map data 1130. The plurality of marks 1340-1, 1340-2, 1340-3, 1340-4, 1340-5, and 1340-6 may be linked to the corresponding image files, respectively.

According to the above embodiments, map data is included in an image file, and thus, a user may detect the map data easily. In general, since the amount of the entire map data is very large, even if location information is present, it takes a lot of time and much processing to search the map data based on the location information. Thus, if the user searches the map data during reproduction of the image file, a time delay may occur due to the large amount of map data. However, according to an embodiment, map data corresponding to a location where an image was captured has been included in an image file, and thus, a user may view and reproduce the map data during reproduction of the image file without having to load a large amount of the entire map data, thereby greatly reducing the time and amount of processing to provide the map data.

According to the above embodiments, map data may be displayed quickly to a user, and thus, location information may be provided faster and more efficiently than when location information is presented according to longitude and latitude.

According to the above embodiments, map data encoded into a format of image data is inserted into an image file, and thus, a user may easily reproduce the map data in the same manner in which the image data is reproduced, during reproduction of the image file.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention.

The apparatus described herein may comprise a processor, a memory for storing program data to be executed by the processor, a permanent storage such as a disk drive, a communications port for handling communications with external devices, and user interface devices, including a display, keys, etc. When software modules are involved, these software modules may be stored as program instructions or computer readable code executable by the processor on a non-transitory computer-readable media such as read-only memory (ROM), random-access memory (RAM), CD-ROMs, DVDs, magnetic tapes, hard disks, floppy disks, and optical data storage devices. The computer readable recording media may also be distributed over network coupled computer systems so that the computer readable code is stored and executed in a distributed fashion. This media may be read by the computer, stored in the memory, and executed by the processor.

The computer readable code may be embodied in such a manner that an image processing method or an image reproducing method according to the invention may be performed when the computer readable code is read and executed by the CPU/DSP 170. Also, using the disclosure herein, programmers of ordinary skill in the art to which the invention pertains may easily implement functional programs, codes, and code segments for making and using the invention.

Also, the invention may be embodied as a non-transitory computer readable recording medium that stores image data and an image file that includes the map data. The image file may have a structure, for example, according to the Exif standards as illustrated in FIG. 3. The image file may include the map data and/or path map data. The image file may further include information indicating whether the map data is present, the attributes of the map data, information indicating whether the path map data is present, and information regarding image files related to the path map data when the path map data is present.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the invention may employ any number of conventional techniques for electronics configuration, signal processing and/or control, data processing and the like. Finally, the steps of all methods described herein may be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. The words “mechanism” and “element” are used broadly and are not limited to mechanical or physical embodiments, but may include software routines in conjunction with processors, etc.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention as defined by the following claims. Therefore, the scope of the invention is defined not by the detailed description of the invention but by the following claims, and all differences within the scope will be construed as being included in the invention.

No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

What is claimed is:

1. An image processing method comprising:
obtaining image data;
obtaining location information regarding a location where the image data has been captured;
obtaining map data presenting a map of a location corresponding to the location information; and
generating an image file to include the image data and the map data.

2. The image processing method of claim 1, further comprising:
loading entire map data; and
searching the entire map data for the map data of the location corresponding to the location information.

3. The image processing method of claim 2, wherein the entire map data comprises at least one of data that has been stored and data obtained from an external device.

4. The image processing method of claim 1, further comprising:
encoding the image data; and
transforming the map data into a format of the image data,
wherein the generating of the image file comprises generating the image file by using the encoded image data and the transformed map data.

5. The image processing method of claim 1, wherein the obtaining of the image data comprises capturing the image data by using an imaging device, and
the obtaining of the location information comprises obtaining global positioning system (GPS) information when the image data has been captured.

6. The image processing method of claim 1, wherein the generating of the image file comprises:
allocating a map data field in an exchangeable image file format (Exif); and
storing the map data in the map data field.

7. The image processing method of claim 1, wherein the generating of the image file further comprises storing information indicating whether the map data is present, in the image file.

8. The image processing method of claim 1, further comprising:
providing a first user interface via which a user selects a plurality of image files;
obtaining a plurality of pieces of location information included in the respective selected image files, and a plurality of pieces of shooting time information about when the respective selected image files have been captured;
generating path information by arranging pieces of location information according to the pieces of shooting time information;
obtaining path map data regarding locations corresponding to the pieces of location information;
inserting marks representing a path of the locations in the path map data; and
storing the path map data in at least one of the selected image files.

9. The image processing method of claim 8, further comprising transforming the path map data into the same format as image data included in the respective selected image files, and
wherein the storing of the path map data in at least one of the selected image files comprises storing the transformed path map data.

10. An image processing apparatus comprising:
an image data obtaining unit that obtains image data;
a location information obtaining unit that obtains location information regarding a location where the image data has been captured;
a map data obtaining unit that obtains map data presenting a map of a location corresponding to the location information; and
a file generation unit that generates an image file to include the image data and the map data.

11. The image processing apparatus of claim 10, wherein the map data obtaining unit comprises:
a map engine that loads entire map data; and
a map search unit that searches the entire map data for the map data of the location corresponding to the location information.

12. The image processing apparatus of claim 11, wherein the entire map data comprises at least one of data that has been stored in the image processing apparatus and data obtained from an external device.

13. The image processing apparatus of claim 10, further comprising:
an image encoding unit that encodes the image data; and
a map transformation unit that transforms the map data into a format of the image data,
wherein the file generation unit generates the image file by using the encoded image data and the transformed map data.

14. The image processing apparatus of claim 10, further comprising an imaging device, and
wherein the image data obtaining unit obtains the image data captured by the imaging device, and
the location information obtaining unit obtains global positioning system (GPS) information when the image data has been captured by the imaging device.

15. The image processing apparatus of claim 10, wherein the file generation unit allocates a map data field in an exchangeable image file format (Exif), and stores the map data in the map data field.

16. The image processing apparatus of claim 10, wherein the file generation unit further includes information indicating whether the map data is present in the image file.

17. The image processing apparatus of claim 10, further comprising:
a first user interface providing unit that provides a first user interface via which a user selects a plurality of image files;
a base information obtaining unit that obtains a plurality of pieces of location information included in the respective selected image files, and a plurality of pieces of shooting time information about when the respective selected image files have been captured;
a path information generation unit that generates path information by arranging pieces of location information according to the pieces of shooting time information;
a path image obtaining unit that obtains path map data regarding locations corresponding to the pieces of location information;
a path insertion unit that inserts marks representing a path of the locations in the path map data; and
a path image storage unit that stores the path map data in at least one of the selected image files.

18. The image processing apparatus of claim 17, further comprising a map transformation unit that transforms the path map data into the same format as image data included in the respective selected image files, and
wherein the path image storage unit stores the transformed path map data.

19. An image reproducing method comprising:
determining whether map data is included in an image file that stores an image; and
if the image file includes the map data, displaying the map data.

20. The image reproducing method of claim 19, further comprising:
if the image file includes the map data, displaying a map mark indicating that the map data is present, together with the image data of the image file,
wherein the displaying of the map data comprises displaying the map data according to a user input that instructs the map mark to be selected.

21. The image reproducing method of claim 19, further comprising:
if the image file includes the map data, determining whether the map data is path map data that presents a path of locations where images included in a plurality of image files have been captured according to time; and
if the map data is the path map data, displaying a list of the plurality of image files related to the path map data.
